(19) United States
(12) Patent Application Publication
(10) Pub. No.: US 2010/0087086 A1
(43) Pub. Date: Apr. 8, 2010

(54) Female Quick Connect Clip For Coaxial Cable

(75) Inventor: Michael D. GOTWALS, Greenwood, IN (US)

Correspondence Address: Pequignot + Myers LLC, 140 Marine View Avenue, Suite 220, Solana Beach, CA, 92075, US

(73) Assignee: ACTERNA LLC, Germantown, MD (US)

(21) Appl. No.: 12/245,860

(22) Filed: Oct. 6, 2008

(51) Int. Cl. H01R 13/627; H01R 9/05

(52) U.S. Cl. 439/358; 439/578

(57) ABSTRACT

When connecting cable test equipment to standard F-connector style coax cables, a technician must use both hands to screw the cable under test into the test equipment or a test lead. In ideal conditions without gloves this is a rather simple task; however, a technician may have to repeat the procedure many times throughout a work day in extreme weather conditions, resulting in the technician having to repeatedly remove their gloves and expose their hands to the cold. A coaxial cable clip connector according to the present invention includes a smooth threadless connector, which fits into the cable under test, and an easily actuated clip, which fits over the coaxial cable connector housing to maintain a solid mechanical and electrical connection.

### TECHNICAL FIELD

The present invention relates to connector for the end of a coaxial cable, and in particular to a quick connect/disconnect coaxial cable connector for connecting test equipment to the female end of a coaxial cable.

### BACKGROUND OF THE INVENTION

Conventional quick connect connectors, such as the ones disclosed in U.S. Pat. No. 6,132,234 issued Oct. 17, 2000 to Waidner et al, and U.S. Pat. No. 7,322,851 issued Jan. 29, 2008 to Brookmire, facilitate the connection of the end of a coaxial cable to a coaxial cable outlet with external threads, e.g. on a TV or wall outlet, so that a cable TV watcher can quickly connect and disconnect the cable extending between the wall outlet and the TV. Male push on connectors are also commonly used, such as those disclosed in U.S. Pat. No. 5,183,412 issued Feb. 2, 1993 to Nagafuji; however, special adaptation to the end of the coaxial cable and the coaxial cable outlet are required.

In the cable test industry connecting test equipment to standard F-connector style coax cables, requires the user to use both hands to screw the cable under test into the test equipment or a test lead. While not extremely time consuming, a technician may have to repeat the procedure many times throughout a work day, which is very difficult to do while wearing gloves, resulting in the technician having to repeatedly remove their gloves in extreme weather conditions.

An object of the present invention is to overcome the shortcomings of the prior art by a coaxial cable clip connector including a threadless connector, which fits into the cable under test, and an easily actuated clip, which fits over the coaxial cable connector housing to maintain a solid mechanical and electrical connection. The mechanical clip is important for field use when the cables under test are attached to the side of a home and/or hang free.

### SUMMARY OF THE INVENTION

Accordingly, the present invention relates to a coaxial cable connector for connecting to a male end of a coaxial cable, which includes a center pin extending therefrom and a rotating outer sleeve with internal threads, comprising:

a cylindrical connector having a central longitudinal recess for receiving the center pin when inserted into the rotating sleeve of the male end of the coaxial cable, the cylindrical connector having an outside diameter slightly smaller than an inside diameter of the internal threads of the rotating outer sleeve to enable the cylindrical connector to be easily slid into the rotating outer sleeve;

a first lever arm including a first jaw biased towards the cylindrical connector in a first direction, and a first handgrip for rotating the first jaw away from the cylindrical connector; and

a second lever arm including a second jaw biased towards the cylindrical connector in a second direction opposite to the first direction, and a second handgrip for rotating the second jaw away from the cylindrical connector.

Another aspect of the present invention relates to A testing device for testing a cable network via a male end of a coaxial cable, which includes a center pin extending therefrom and a rotating outer sleeve with internal threads, comprising:

a testing module for sending test signals or receiving test data;

a coaxial cable lead extending from the testing module for transmitting test signals from the testing module, and for receiving test data from the cable network;

a coaxial cable connector on the outer free end of the coaxial lead comprising:

a cylindrical connector having a central longitudinal recess for receiving the center pin when inserted into the rotating sleeve of the male end of the coaxial cable, the cylindrical connector having an outside diameter slightly smaller than an inside diameter of the internal threads of the rotating outer sleeve to enable the cylindrical connector to be easily slid into the rotating outer sleeve;

a first lever arm including a first jaw biased towards the cylindrical connector in a first direction, and a first handgrip for rotating the first jaw away from the cylindrical connector; and

a second lever arm including a second jaw biased towards the cylindrical connector in a second direction opposite to the first direction, and a second handgrip for rotating the second jaw away from the cylindrical connector.

### BRIEF DESCRIPTION OF THE DRAWINGS

The invention will be described in greater detail with reference to the accompanying drawings which represent preferred embodiments thereof, wherein:

FIG. 1 illustrates a side view of the coaxial cable clip of the present invention as it is being positioned on the end of a coaxial cable;

FIG. 2 illustrates a side view of the clip of FIG. 1 positioned on the end of a coaxial cable;

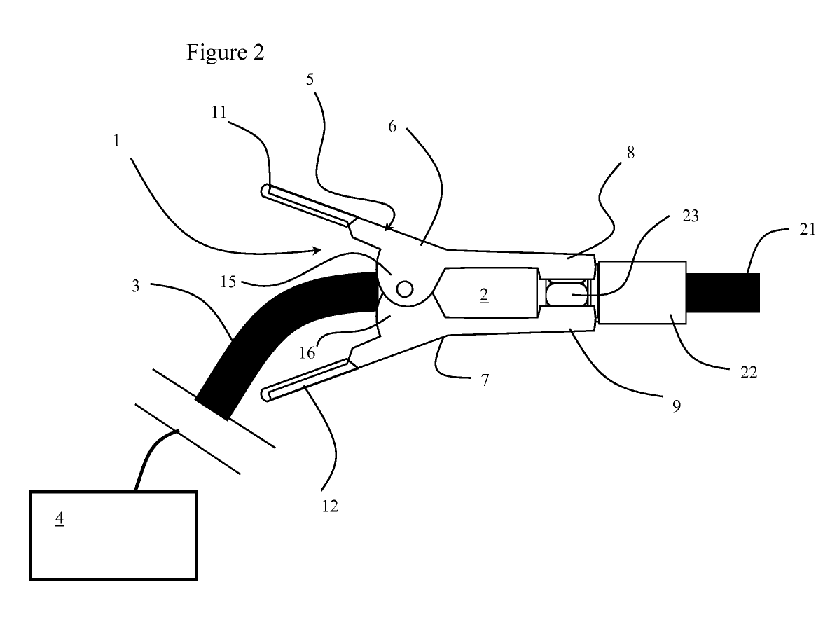

FIG. 3 is a cross-sectional view of the clip of FIG. 2 illustrating the conductors in contact; and

FIGS. 4a and 4b are end views of alternative jaw sections for the cable clip of FIGS. 1 to 3.

### DETAILED DESCRIPTION

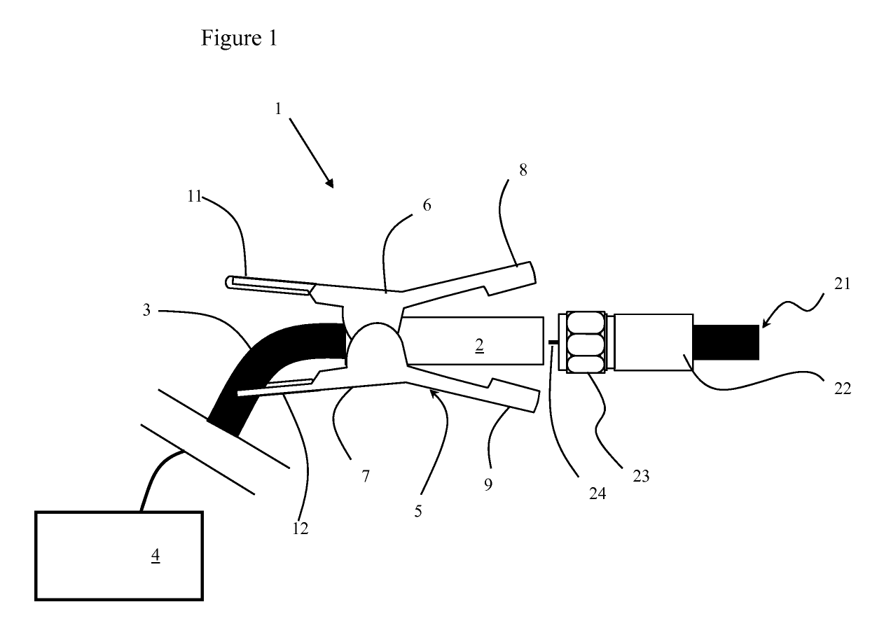

With reference to FIG. 1, the coaxial cable connector clip device 1 of the present invention includes an F-connector cylinder or barrel 2 mounted on an end of a coaxial cable section 3, e.g. RG-6 coaxial cable, which extends to testing equipment 4, such as a JDSU SmartClass® testing device. A spring-loaded clip 5 is comprised of first and second lever arms 6 and 7, with jaw sections 8 and 9, respectively, which are pivotally mounted on the barrel 2, whereby the first and second jaw sections 8 and 9 are diametrically opposed, and can be moved towards and away from each other by movement of the first and second handgrips 11 and 12 extending from the opposite ends of the first and second lever arms, respectively. The first and second lever arms 6 and 7 are pivotally mounted to the barrel 2 proximate their middles via bracket or ear sections 15 and 16. The first and second jaw sections 8 and 9 are spring biased towards each other by a spring extending between the first and second lever arms 6 and 7 or other spring mechanism, such as forming the first and second lever arms out of a resilient material biased in the closed position, as is well known in the art.

Preferably, the first handgrip 11 is angled upwardly at an acute angle from a horizontal line extending from along the axis of the first jaw section 8, thereby forming an obtuse angle between the first handgrip 11 and the first jaw section 8. Similarly, the second handgrip 12 and the second jaw section 9 from an obtuse angle therebetween, whereby the first and second handgrips 11 and 12 form an acute angle therebetween, when the first and second jaw sections 8 and 9 are biased together or a cable connector.

The end of a conventional coaxial cable under test 21 is provided with a standard 75 ohm compression connector 22, which includes a rotating sleeve 23 surrounding the exposed metal conductive pin 24. The rotating sleeve 23 includes internal threads, for mating with externally threaded wall or television connectors, and external gripping features for facilitating manual gripping during standard connection. Typical external gripping features include a multi-faceted structure, e.g. hexagonal, and a cylindrical structure with knurled sections for gripping.

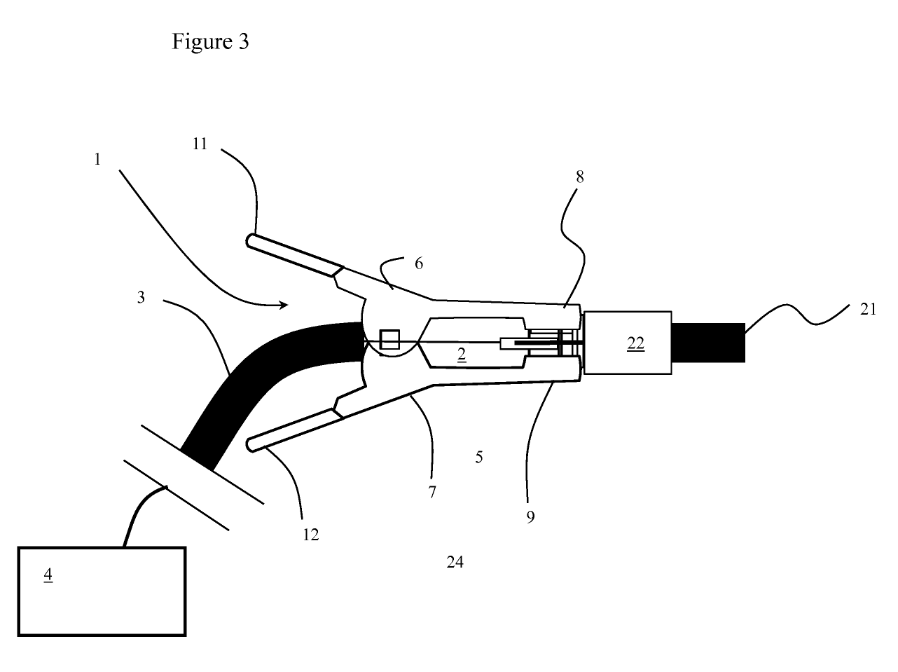

The barrel connector 2 is a F-connector barrel with a smooth outer surface without any threads on one end, and a outside diameter slightly smaller than the inside diameter of the threads of the rotating sleeve 23 of the male F-connector 22 to enable the barrel 2 to be easily slid into the rotating sleeve 23 of the male connector 22. The barrel connector 2 has a central longitudinal recess and has sufficient length for engaging the center pin 24 when inserted into the rotating sleeve 23 of the male F-connector 22. See FIG. 3 for cross-sectional view. Pivotally mounted to the barrel 2 is the spring loaded clip 5 that clips over the rotating sleeve 23 of the connector 22 to maintain a mechanical connection. The spring clip 5 will also insure proper grounding, because the conductive, e.g. metallic, jaws 8 and 9 and the lever arms 6 and 7 of the clip 5 are grounded, as is the external housing of the cables 3 and 21, i.e. by clipping the jaws 8 and 9 to the outer housing of the cable 21 the two grounds are connected. The user would squeeze the clip 5, push the barrel 2 in the rotating sleeve 23 of the male F-connector 22, and then release the first and second lever arms 6 and 7 to attach the test cable 3. The cable under test 21 is released by squeezing the first and second lever arms 6 and 7, and pulling the barrel 2 out of the rotating sleeve 23 of the male connector 22.

The push and clip operation can be preformed quickly and without removing your gloves. Accordingly, the present invention will reduce the time a technician spends on a service call and in turn enable the technician to execute more service calls in a given day without exposing the technicians hands to the elements.

The other end of the barrel 2 can be a standard threaded barrel end for screwing into a male F-connector at the end of the coaxial cable segment 3, which enables the technician to replace the coaxial cable segment 3 between the coax clip 1 and the test instrument 4.

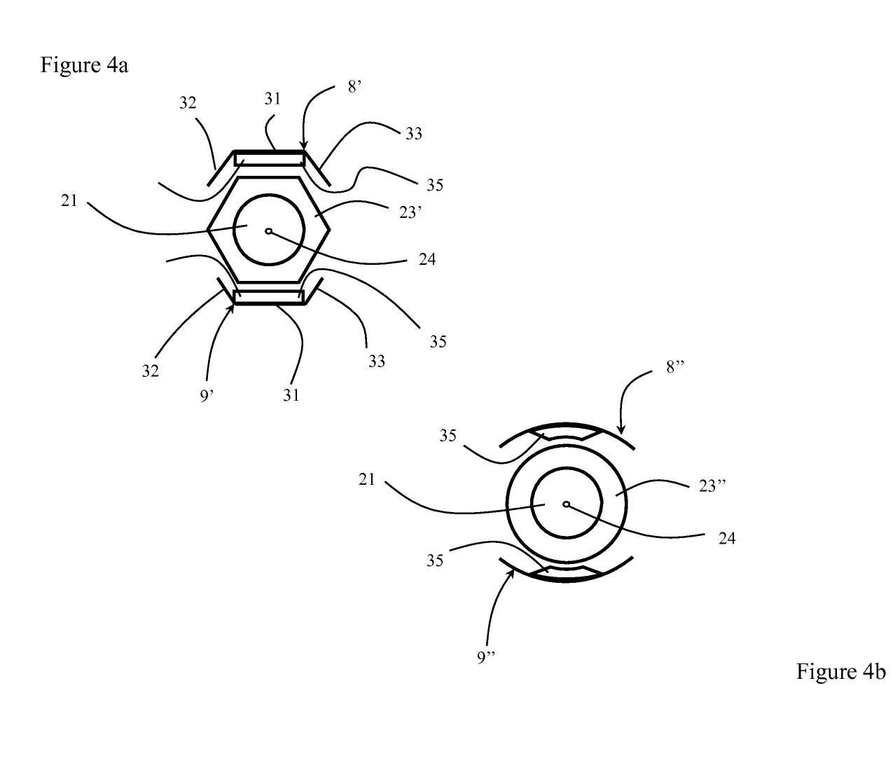

With reference to FIGS. 4a and 4b, the first and second jaw sections 8 and 9 can have a shape corresponding to the outer shape of the male F-connector 22, e.g. the shape of the rotating sleeve 23. FIG. 4a illustrates first and second jaw sections 8′ and 9′ including a central section 31 and two wing sections 32 and 33 at an acute angle, e.g. 60°, from the central section 31 for mating with a hexagonal shaped rotating sleeve 23′. First and second jaw sections 8″ and 9″, illustrated in FIG. 4b have an arcuate shape, preferably with knurled sections, for mating with a cylindrically shaped rotating sleeve 23″.

Ideally, the outer free edge of each of the first and second jaw sections 8, 8′, 9, 9′ and includes a rectangular tooth 35 extending perpendicular thereto for extending behind the rotating sleeve 23 and preventing the first and second jaw sections, i.e. the clip 5 from slipping off the rotating sleeve 23 without the first and second lever arms 6 and 7 from being rotated apart. Similarly, an arcuate tooth 45 can be provided at the outer edge of each of the first and second jaw sections 8″ and 9″ for extending behind the rotating sleeve 23 and preventing the first and second jaw sections, i.e. the clip 5 from slipping off the rotating sleeve 23 without the first and second lever arms 6 and 7 from being rotated apart.

We claim:

1. A coaxial cable connector for connecting to a male end of a coaxial cable, which includes a center pin extending therefrom and a rotating outer sleeve with internal threads, comprising:
a cylindrical connector having a central longitudinal recess for receiving the center pin when inserted into the rotating sleeve of the male end of the coaxial cable, the cylindrical connector having an outside diameter slightly smaller than an inside diameter of the internal threads of the rotating outer sleeve to enable the cylindrical connector to be easily slid into the rotating outer sleeve;
a first lever arm including a first jaw biased towards the cylindrical connector in a first direction, and a first handgrip for rotating the first jaw away from the cylindrical connector; and
a second lever arm including a second jaw biased towards the cylindrical connector in a second direction opposite to the first direction, and a second handgrip for rotating the second jaw away from the cylindrical connector.

2. The coaxial cable connector according to claim 1, wherein the first and second lever arms are pivotally connected to the cylindrical connector proximate the middle thereof.

3. The coaxial cable connector according to claim 1, further comprising first and second springs for biasing the first and second jaws, respectively, towards the cylindrical connector.

4. The coaxial cable connector according to claim 1, wherein the first and second lever arms, each comprise a resilient material for biasing the first and second jaws, respectively, towards the cylindrical connector.

5. The coaxial cable connector according to claim 1, wherein the cylindrical connector comprises an F-connector barrel with a smooth outer surface without any threads on one end

6. The coaxial cable connector according to claim 1, wherein the first and second jaws include a central section and first and second wing sections extending at an acute angle from either side of said central section for mating with a hexagonal-shaped rotating outer sleeve.

7. The coaxial cable connector according to claim 6, further comprising a tooth extending from the first jaw for extending behind the rotating outer sleeve and preventing the first jaw from slipping off the rotating outer sleeve without the first lever arm from being rotated away from the cylindrical connector.

8. The coaxial cable connector according to claim 1, wherein the first and second jaws include an arcuate section for mating with an arcuate-shaped rotating outer sleeve.

9. The coaxial cable connector according to claim 8, further comprising a tooth extending from the first jaw for extending behind the rotating outer sleeve and preventing the first jaw from slipping off the rotating outer sleeve without the first lever arm from being rotated away from the cylindrical connector.

10. A testing device for testing a cable network via a male end of a coaxial cable, which includes a center pin extending therefrom and a rotating outer sleeve with internal threads, comprising:
a testing module for sending test signals or receiving test data;
a coaxial cable lead extending from the testing module for transmitting test signals from the testing module, and for receiving test data from the cable network;
a coaxial cable connector on the outer free end of the coaxial lead comprising:
a cylindrical connector having a central longitudinal recess for receiving the center pin when inserted into the rotating sleeve of the male end of the coaxial cable, the cylindrical connector having an outside diameter slightly smaller than an inside diameter of the internal threads of the rotating outer sleeve to enable the cylindrical connector to be easily slid into the rotating outer sleeve;
a first lever arm including a first jaw biased towards the cylindrical connector in a first direction, and a first handgrip for rotating the first jaw away from the cylindrical connector; and
a second lever arm including a second jaw biased towards the cylindrical connector in a second direction opposite to the first direction, and a second handgrip for rotating the second jaw away from the cylindrical connector.

11. The coaxial cable connector according to claim 10, wherein the first and second lever arms are pivotally connected to the cylindrical connector proximate the middle thereof.

12. The coaxial cable connector according to claim 10, further comprising first and second springs for biasing the first and second jaws, respectively, towards the cylindrical connector.

13. The coaxial cable connector according to claim 10, wherein the first and second lever arms, each comprise a resilient material for biasing the first and second jaws, respectively, towards the cylindrical connector.

14. The coaxial cable connector according to claim 10, wherein the cylindrical connector comprises an F-connector barrel with a smooth outer surface without any threads on one end

15. The coaxial cable connector according to claim 10, wherein the first and second jaws include a central section and first and second wing sections extending at an acute angle from either side of said central section for mating with a hexagonal-shaped rotating outer sleeve.

16. The coaxial cable connector according to claim 15, further comprising a tooth extending from the first jaw for extending behind the rotating outer sleeve and preventing the first jaw from slipping off the rotating outer sleeve without the first lever arm from being rotated away from the cylindrical connector.

17. The coaxial cable connector according to claim 10, wherein the first and second jaws include an arcuate section for mating with an arcuate-shaped rotating outer sleeve.

18. The coaxial cable connector according to claim 17, further comprising a tooth extending from the first jaw for extending behind the rotating outer sleeve and preventing the first jaw from slipping off the rotating outer sleeve without the first lever arm from being rotated away from the cylindrical connector.
